(19) United States
(12) Patent Application Publication
(10) Pub. No.: US 2015/0333971 A1
(43) Pub. Date: Nov. 19, 2015

(54) METHOD AND DEVICE FOR MANAGING PROCESSES OF APPLICATION PROGRAM

(71) Applicant: Xiaomi Inc., Beijing (CN)

(72) Inventors: Wenjun Wang, Beijing (CN); Jun Yuan, Beijing (CN); Qiwu Huang, Beijing (CN); Wei Han, Beijing (CN)

(21) Appl. No.: 14/586,968

(22) Filed: Dec. 31, 2014

Related U.S. Application Data
(63) Continuation of application No. PCT/CN2014/089218, filed on Oct. 22, 2014.

(30) Foreign Application Priority Data
May 14, 2014 (CN) 201410203339.1

(51) Int. Cl. H04L 12/24; G06F 3/0484

(52) U.S. Cl. CPC H04L 41/22; G06F 3/04842

(57) ABSTRACT

The present disclosure provides a method and device for managing processes of an application program. The method and device relate to the field of electronic terminal devices, which may significantly save processing resources of the electronic terminal devices so as to improve the efficiency of using the resources. The method of the present disclosure generally includes steps of switching an application program from running in foreground to running in background, wherein processes of the application program comprise a user interface (UI) process and a logic process and terminating the UI process of the application program and keeping the logic process of the application program running. The embodiments of the present disclosure are generally used to manage application programs in electronic terminal devices.

### CROSS-REFERENCE TO RELATED APPLICATIONS

This application is a Continuation of International Application PCT/CN2014/089218, with an international filing date of Oct. 22, 2014, which claims priority to Chinese Patent Application No. 201410203339.1, filed on May 14, 2014, the entire contents of which are incorporated herein by reference.

### TECHNICAL FIELD

The present disclosure generally relates to electronic terminal devices, and more particularly, to a method and device for managing processes of an application program.

### BACKGROUND

Nowadays, there are a great many application programs designed for mobile phones, pads and other electronic terminal devices. It frequently occurs that multiple application programs are simultaneously running on a single electronic terminal device. Moreover, the application may run on the electronic terminal device in two ways. The first way is running in foreground, i.e. directly running in the window or interface displayed by the screen, and a current interface of the running application is shown, through which a user of the electronic terminal device may interact with the electronic terminal device. The second way is running in background, i.e. the interface of the running application is not shown on the screen, but the application keeps providing services and can be switched to be shown foreground any time as desired.

When using the electronic terminal devices, it is frequently required to switch the application from running in foreground to running in background. For example, when the user opens a music application and starts to play music, a User Interface (UI) of the music application would be processed by certain processes of the music application and then displayed. The interface may include play control buttons, an album cover, song information, scrolling lyrics and so on. At the same time, the user may switch the music application to run in background, open a backup application to backup data in the terminal device. Accordingly, a UI of the backup application including backup control buttons and backup schedule would be processed by processes of the backup application and displayed. When the backup operation is in progress, the user can also switch to a home page to perform other operations, which may not be elaborated herein.

For the aforementioned scenarios, conventional methods may keep running all processes of the application switched to running in background. All data, services and UI will be processed as the application is running in foreground, just having the UI of the application hidden. When the application is switched to running in foreground again, the UI may be displayed.

### SUMMARY

The embodiments of the present disclosure provide a method and a device for managing processes of an application program, which significantly save processing resources of an electronic terminal device, thereby improving the efficiency of using the resources.

According to a first aspect of the present disclosure, a method for managing processes of an application program is provided. The method includes switching an application program from running in foreground to running in background, wherein processes of the application program comprise a user interface (UI) process and a logic process; and terminating the UI process of the application program and keeping the logic process of the application program running.

According to a second aspect of the present disclosure, a device for managing processes of an application program is provided. The device includes a processor; and a memory for storing instructions executable by the processor; wherein the processor is configured to perform switching an application program from running in foreground to running in background, wherein processes of the application program comprise a user interface (UI) process and a logic process; and terminating the UI process of the application program and keeping the logic process of the application program running.

According to a third aspect of the present disclosure, there is provided a non-transitory storage medium having stored therein instructions that, when executed by one or more processors of a device for an application program, causes the device to perform switching an application program from running in foreground to running in background, wherein processes of the application program comprise a user interface (UI) process and a logic process; and terminating the UI process of the application program and keeping the logic process of the application program running.

The solutions provided by the embodiments of the present disclosure may have the following advantages: by running the UI processes and the logic processes of the application program separately, when the application program is switched to running in background, the logic processes needed by the user may keep running and the UI processes unconcerned by the user may be terminated. Compared with the manner that the operation of the application program is assembled in a single process and the assembled process is kept running in background, the solutions of the embodiments of the present disclosure may save CPU processing resources and memory space occupied by the UI processing when the application program is switched to running in background, thus reducing power consumption of the electronic terminal device when many application program are running simultaneously. Moreover, as the CPU processing resources are avoided being wasted, the efficiency of using the resources can be improved and the heat generation of the electronic terminal device can be reduced.

It is to be understood that, both the foregoing general description and the following detailed description are exemplary and explanatory only, and do not limit the disclosure.

### BRIEF DESCRIPTION OF THE DRAWINGS

The accompanying drawings, which are incorporated in and constitute a part of this specification, illustrate embodiments consistent with the application and, together with the description, serve to explain the principles of the application.

FIG. 1 is a flow chart of a method for managing processes of an application program according to an exemplary embodiment;

FIG. 2 is a flow chart of a method for managing processes of an application program according to another exemplary embodiment;

FIG. 3 is a flow chart of a method for managing processes of an application program according to another exemplary embodiment;

FIG. 4 is a flow chart of a method for managing processes of an application program according to another exemplary embodiment;

FIG. 5 is a flow chart of a method for managing processes of an application program according to another exemplary embodiment;

FIG. 6 is a block diagram of an apparatus for managing processes of an application program according to an exemplary embodiment;

FIG. 7 is a block diagram of another apparatus for managing processes of an application program according to another exemplary embodiment;

FIG. 8 is a block diagram of another apparatus for managing processes of an application program according to another exemplary embodiment;

FIG. 9 is a block diagram of another apparatus for managing processes of an application program according to another exemplary embodiment;

FIG. 10 is a block diagram of another apparatus for managing processes of an application program according to another exemplary embodiment;

FIG. 11 is a block diagram of a device for managing processes of an application program according to an exemplary embodiment; and

FIG. 12 is a block diagram of a device for managing processes of an application program according to another exemplary embodiment.

### DESCRIPTION OF THE EMBODIMENTS

Illustration may now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the application. Instead, they are merely examples of apparatuses and methods consistent with aspects related to the application as recited in the appended claims.

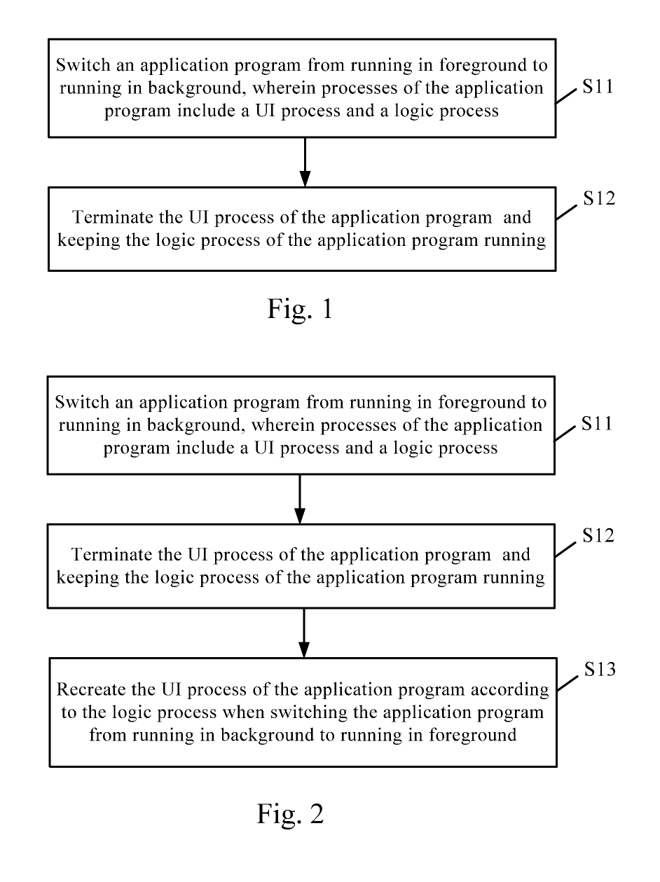

FIG. 1 is a flow chart of a method for managing processes of an application program according to an exemplary embodiment. As shown in FIG. 1, the method for managing processes of the application program may be used in a terminal device, and includes the following steps.

In step S11, the application program is switched from running in foreground to running in background, wherein processes of the application program include a UI process and a logic process.

The difference in process management of the application program between the present disclosure and related technologies is that, the application program in related technologies generally has only one process in which subprograms of services, data, algorithms and UIs are intricately processed. However, in the method of the present disclosure, the application program has some subprograms related to service, data or algorithm, which may be processed together in the logic process, while other subprograms of the application programs that are not closely related to the core service, data or algorithm and are usually related to the UI can be processed together in the UI process.

For example, play control buttons, album cover, song information, scrolling lyrics and the like of a music application program may be classified into the UI process for execution, so that these programs may be terminated when the music application program is switched to run in background. However, service programs of the application program such as music play, music data download, etc., may be classified into the logic process for execution, so that these programs can continue running even the music application program is switched to running in background. Similarly, many applications such as radio, backup, stock and weather applications and the like, can be classified into the UI process and the logic process in a similar manner, and the UI process and the logic process may run separately.

In step S12, the UI process of the application program is terminated and the logic process of the application program is kept running.

In certain embodiments of the present disclosure, the UI process and logic process run separately as described in step S11, therefore, the two processes may be handled differently when the application program is switched to running in background. On one hand, the application program is merely switched from running in foreground to running in background, and the user may not want to close the program. Thus, in order to ensure the full application function of the terminal device, the application program running in background still continues providing corresponding service, namely continues running the corresponding logic process of the application program. On the other hand, as the user switches the application program to running in background to display other interface or to shut down the screen, the user may not aware an UI interface of the application program running in background. However, calculation or processing of the UI interface may occupy a lot processing resources, which are sometimes several times of those occupied by the logic process. Thus, in order to reduce resource occupancy, when the application program is running in background, its UI interface need not to be calculated or processed any more, namely the UI process can be terminated.

Further, FIG. 2 is a flow chart of a method for managing processes of an application program according to another exemplary embodiment. As shown in FIG. 2, the method may include the following steps.

In step S13, when an application program is switched from running in background to running in foreground, a UI process of the application program is recreated according to the logic process.

Although the UI process is terminated while the application program runs in background, a UI interface of the application program shall be displayed timely and accurately when the application program is switched to running in foreground. When the application program is switched to running in foreground, the UI process may be restarted and recover completely. Therefore, after the UI process is restarted, the logic process is accessed first to get its status, and the corresponding UI interface of the current logic process may be calculated.

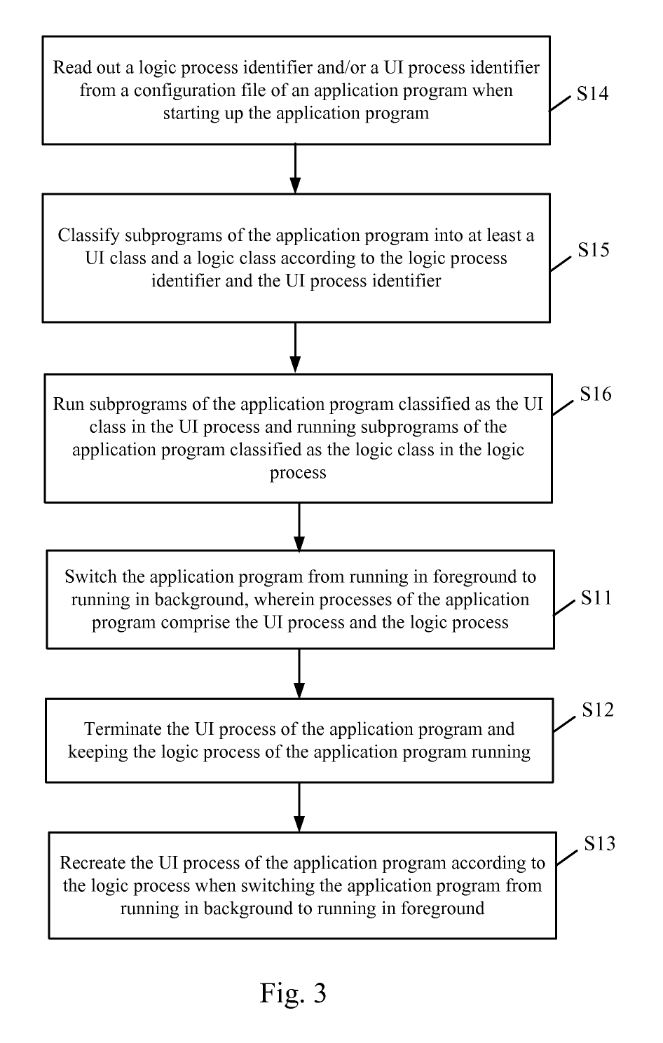

Further, FIG. 3 is a flow chart of a method for managing processes of an application program according to another exemplary embodiment. As shown in FIG. 3, before step S11, the method may further include the following steps.

In step S14, when the application program is started up, a logic process identifier and/or a UI process identifier in a configuration file of the application program is read out.

During the development of the application program, the developer can apply the corresponding identification in the configuration file of the application program to implement the strategy of separating the logic process and the UI process according to the present disclosure. The identification manner may include labeling the processes that are not allowed to be terminated. For example, a server, data or other processes may be label with an identifier “process” or “logic”. The identifier “process” or “logic” illustrated here may be considered as the logic process identifier, so that when the application program is run by the operating system, the programs corresponding to the identifier “logic” are assembled into the logic process for running, and the other programs are placed into the UI process for running. It can be understood that, in the configuration file of the application program, the programs related to the UI can also be labeled with the UI process identifier. Similarly, the programs with the UI process identifiers are placed into the UI process for running, and the other programs run as logic processes that are not allowed to be terminated even if the application program is running in background. Alternatively, the UI-related programs may be labeled with the UI process identifier and the logic-related programs may be labeled with the logic process identifier, which may not be limited by the embodiments of the present disclosure.

In step S15, according to the logic process identifier and/or the UI process identifier, subprograms of the application program are classified into different process classes including at least a UI class and a logic class.

Take a music application program as an example, the configuration file of the music application program is named as “AndroidManifest.xml”, and the configuration file includes elements Activity, Service, Provider and Receiver.

Below are brief descriptions of the elements and which class the elements are classified into:

(1) Activity: corresponding to components of the UI interface, e.g. the music list, player view and other similar visible components. The Activity element belongs to the UI process.

(2) Service: player services in background. The Service element belongs to the logic process.

(3) Provider: music data such as currently accessible music and the authors of the music. The Provider element belongs to the logic process.

(4) Receiver: some actions triggered after the system broadcast is received, e.g. starting to play a song when it is downloaded completely. The Receiver element belongs to the logic process.

In step S16, the UI process and the logic process are run according to the classified process classes, wherein the subprograms of the UI class are run in the UI process, and the subprograms of the logic class are run in the logic process.

In this case, based upon the classified result in step S15, the UI process is established to run the subprograms classified as the UI class, and the logic process is established to run the subprograms classified as the logic class. For example, all Activity elements in the music application are run in the UI process, and all of the Service, Provider and Receiver elements are run in the logic process.

It shall be noted that, if step S15 can be realized, i.e. the subprograms which are allowed or not allowed to be terminated when the application program is running in background may be defined in the configuration file of the application program, then the processing resources may be significantly saved by using the method according to the embodiments of the present disclosure. However, as there are many different development teams working on various application programs, some of the configuration files of the application programs may not conform to the strategy of separating the UI process and the logic process according to the present disclosure. Thus, in order to avoid terminating necessary background programs of the application program and affecting the normal use of the application program, the application programs may be processed in different manners. For example, for the application program that conforms to the strategy of separating the UI process and the logic process, when it runs in background, its UI process is terminated. Moreover, for the application program that does not conform to the strategy of separating the UI process and the logic process, when it runs in background, all of its programs continue running.

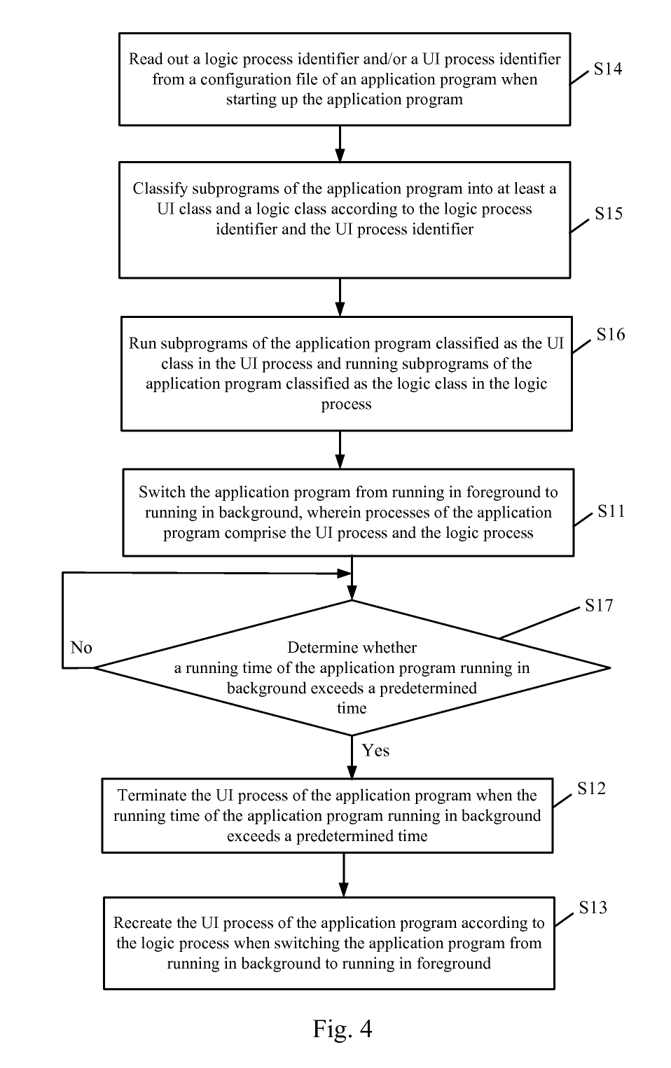

Further, in one alternative embodiment, as shown in FIG. 4, in order to ensure fluently switching of interfaces and avoid frequently terminating and recreating the UI process, a judgment of time may be added after the application program is switched to running in background and before the UI process is terminated. Specifically, after step S11, the method may further include the following steps.

In step S17, it is determined whether a running time of the application program runs in background exceeds a predetermined time.

When the running time of the application program running in background exceeds the predetermined time, proceed with step S12. Moreover, when the running time of the application program running in background does not exceed the predetermined time, proceed with step S17. It can be understood that, if the application program is switched to running in background and the timing is started, and the application program returns to running in foreground without reaching the predetermined time, the timing can be ended. Moreover, if the application program is switched to running in background again, a new round of timing can be started. The predetermined time may be preconfigured during the development of the application program, and may alternatively be set by the user. For example, the predetermined time length may be 5 seconds or 10 seconds, etc.

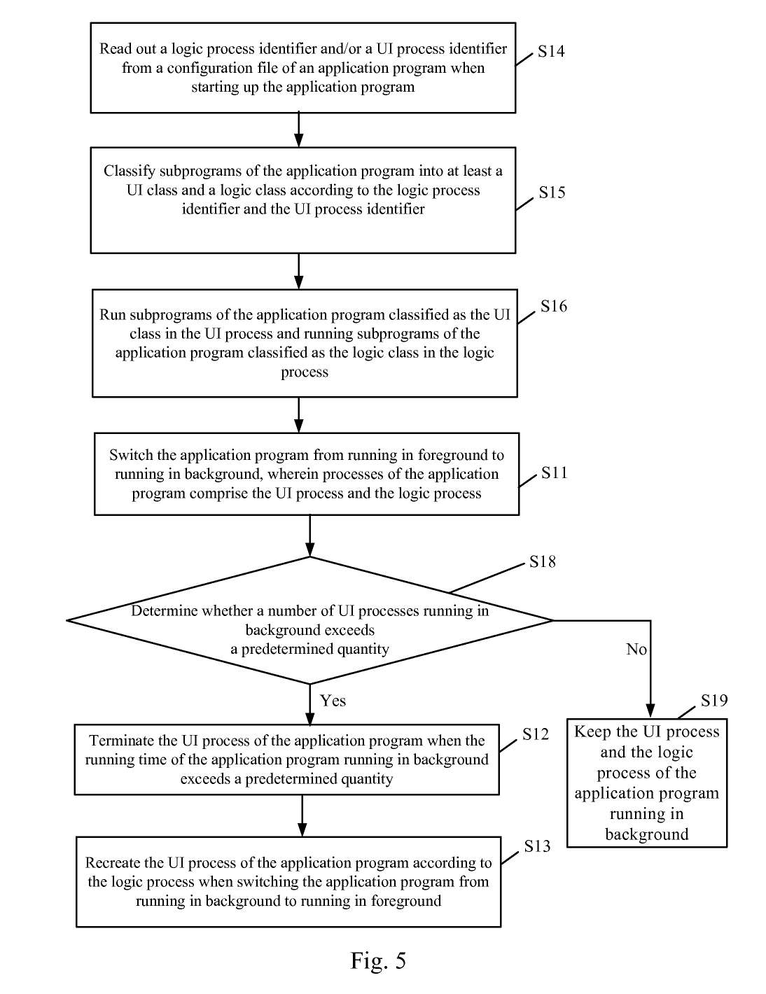

In another alternative embodiment, as shown in FIG. 5, in addition to the judgment of time, other judgment may also be used to determine whether or not to terminate the background UI process. Specifically, after step S11, the method can further include the following steps.

In step S18, it is determined whether a quantity of UI processes running in background exceeds a predetermined quantity.

When the quantity of the UI processes reaches the predetermined quantity, proceed with step S12. If the quantity of the UI processes running in foreground and background does not reach the predetermined quantity, which may be deemed that there are relatively adequate space of the processing resources available for processing processes, proceed with step S19. The predetermined quantity may be preconfigured during the development of the application program, and may alternatively be set by the user. For example, the predetermined quantity may be 5 or 10, etc.

In step S19, the UI process and the logic process of the application program is kept running in background.

As the quantity of the UI processes running in foreground and background does not reach the predetermined quantity, the UI processes of the application program may not be terminated, and the UI processes and the logic processes may still run simultaneously even the application program is switched to running in background. When the quantity of the UI processes reaches the predetermined quantity, in order to avoid over occupancy of the processing resources, the UI processes of the application program that are subsequently switched to running background may be terminated.

For the method for managing processes of the application program according to exemplary embodiments of the present disclosure, by running the UI processes and the logic processes of the application program separately, when the application program is switched to running in background, the logic processes needed by the user may keep running and the UI processes unconcerned by the user may be terminated. Compared with the manner that the operation of the application program is assembled in a single process and the assembled process is kept running in background, the solutions of the embodiments of the present disclosure may save CPU processing resources and memory space occupied by the UI processing when the application program is switched to running in background, thus reducing power consumption of the electronic terminal device when many application program are running simultaneously. Moreover, as the CPU processing resources are avoided being wasted, the efficiency of using the resources can be improved and the heat generation of the electronic terminal device can be reduced.

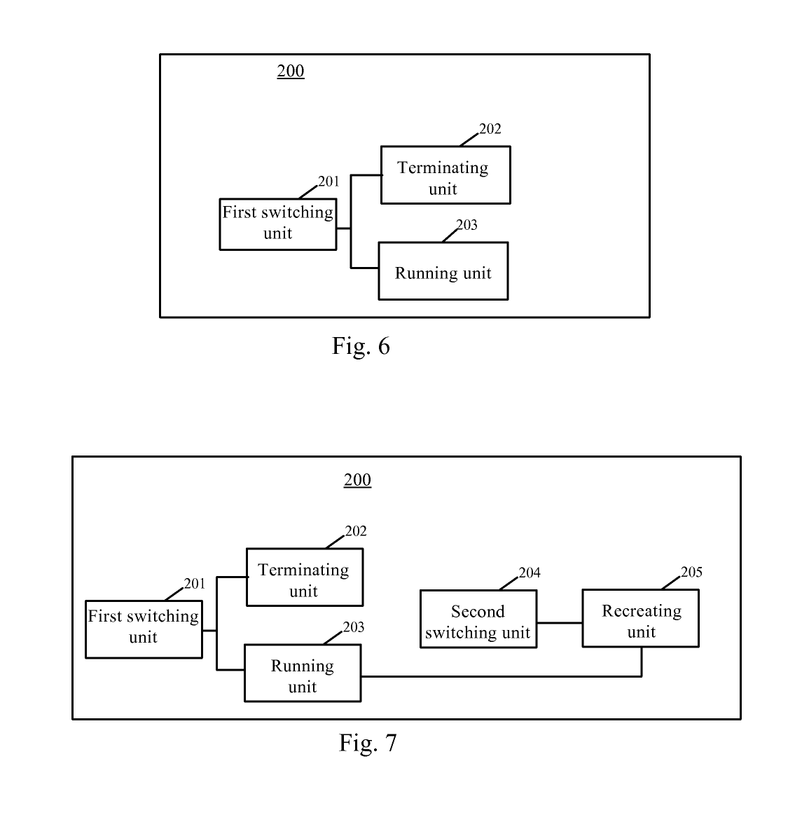

FIG. 6 is a block diagram of an apparatus 200 for managing processes of an application program according to an exemplary embodiment. As shown in FIG. 6, the apparatus 200 includes a first switching unit 201, a terminating unit 202 and a running unit 203.

The first switching unit 201 is configured to switch an application program from running in foreground to running in background, wherein processes of the application program comprise a user interface process and a logic process.

The terminating unit 202 is configured to terminate the UI process of the application program after the first switching unit 201 switches the application program from running foreground to running background.

The running unit 203 is configured to keep the logic process of the application program running after the first switching unit 201 switches the application program from running in foreground to running background.

Further, as shown in FIG. 7, the apparatus 200 may include a second switching unit 204 and a recreating unit 205.

The second switching unit 204 is configured to switch the application program from running in background to running in foreground.

The recreating unit 205 is configured to recreating the UI process according to the logic process after the second switching unit 204 switches the application program from running in background to running in foreground.

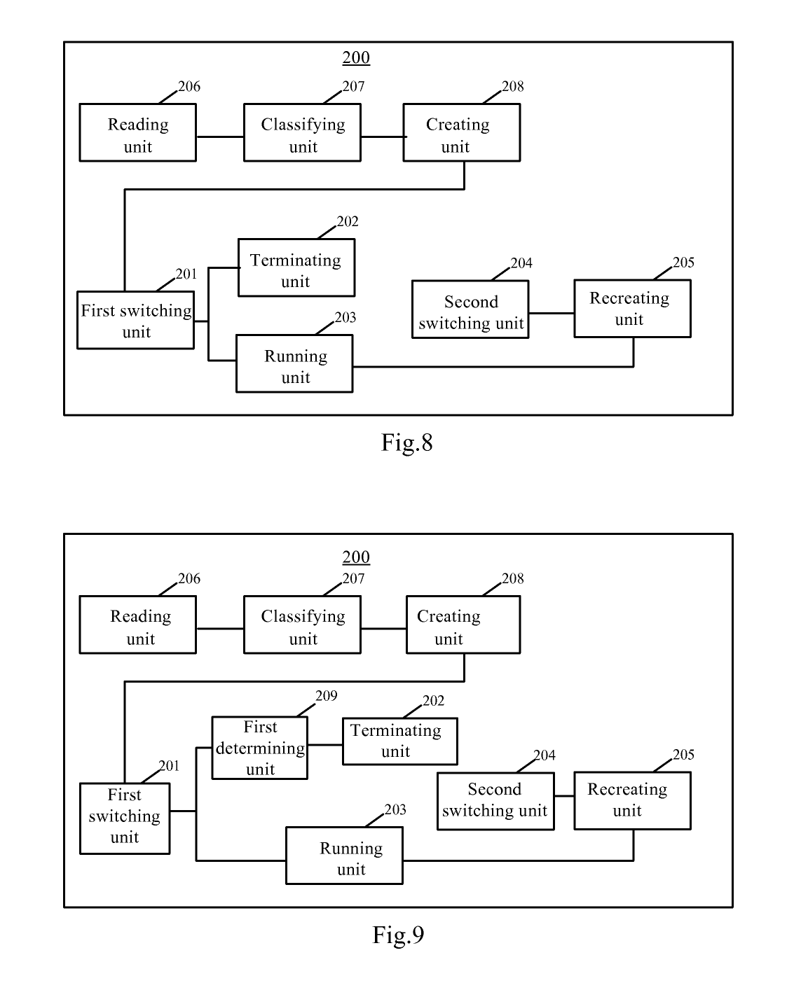

Further, as shown in FIG. 8, the apparatus 200 may include: a reading unit 206 configured to read out a logic process identifier and/or a UI process identifier from a configuration file of the application program when starting up the application program, before the first switching unit 201 switches the application program from running in foreground to running background; a classifying unit 207 configured to classify subprograms of the application program into at least a UI class and a logic class according to the logic process identifier and the UI process identifier read out by the reading unit 206, wherein the process classes include an UI class and a logic class; and a creating unit 208, configured to create the UI process and the logic process according to the process classes classified by the classifying unit 207, wherein the subprograms classified as the UI class run in the UI process, and the subprograms classified as the logic class run in the logic process.

Further, as shown in FIG. 9, in one alternative embodiment, the apparatus 200 may include: a first determining unit 209 configured to determine a running time of the application program running background after the first switching unit 201 switches the application program from running in foreground to running background; and the terminating unit 202 further configured to terminate the UI process of the application program after the running time determined by the first determining unit 209 exceeds the predetermined time.

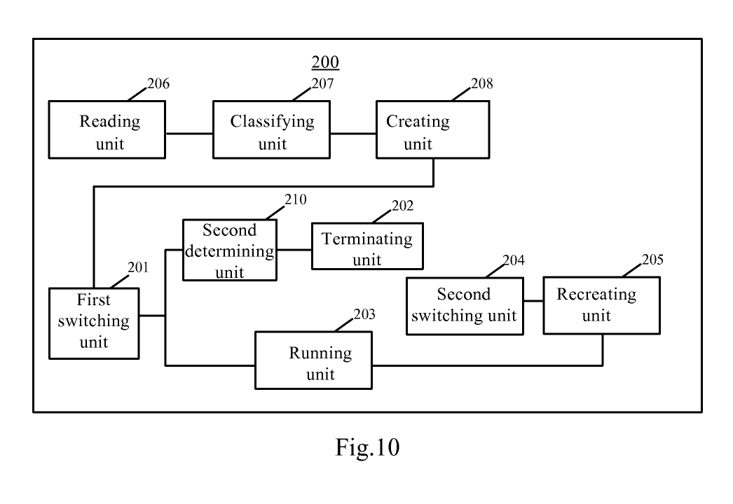

As shown in FIG. 10, in another alternative embodiment, the apparatus 200 may further include: a second determining unit 210 configured to determine a quantity of UI processes running background after the first switching unit 201 switches the application program from running in foreground to running background; and the terminating unit 202 further configured to terminate the UI processes of the application program after the quantity of the other UI processes determined by the second determining unit 210 exceeds a predetermined quantity.

With regard to the apparatuses according to above-mentioned embodiments, specific manners in which the respective units perform operations have been described with reference to embodiments of the corresponding methods, which will not be elaborated herein.

In the processing apparatus 200 for the application program according to exemplary embodiments of the present disclosure, by running the UI processes and the logic processes of the application program separately, when the application program is switched to running in background, the logic processes needed by the user may keep running and the UI processes unconcerned by the user may be terminated. Compared with the manner that the operation of the application program is assembled in a single process and the assembled process is kept running in background, the solutions of the embodiments of the present disclosure may save CPU processing resources and memory space occupied by the UI processing when the application program is switched to running in background, thus reducing power consumption of the electronic terminal device when many application program are running simultaneously. Moreover, as the CPU processing resources are avoided being wasted, the efficiency of using the resources can be improved and the heat generation of the electronic terminal device can be reduced.

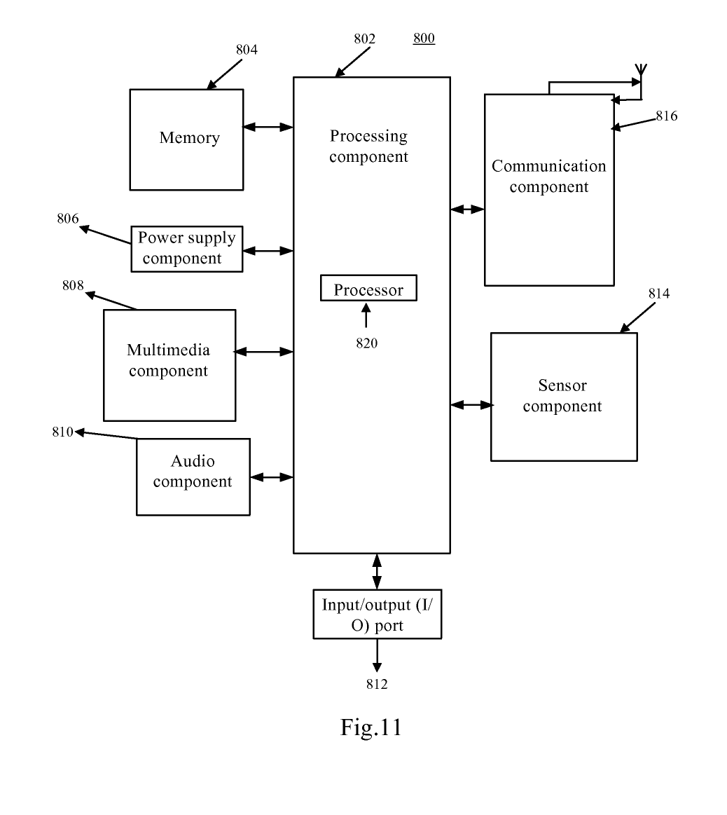

FIG. 11 is a block diagram of a device 800 for managing processes of an application program according to an exemplary embodiment. For instance, the device 800 may be a mobile phone, computer, digital broadcasting terminal, information transceiver, game console, pad equipment, medical equipment, fitness equipment, personal digital assistant and so on.

Referring to FIG. 11, the processing device 800 may include one or more following components: processing component 802, memory 804, power supply component 806, multimedia component 808, audio component 810, input/output (I/O) port 812, sensor component 814 and communication component 816.

The processing component 802 usually controls the overall operations of the processing device 800, such as operations related to displaying, calling, data communication, camera operation and recording operation. The processing component 802 may include one or more processors 820 configured to perform instructions to complete all or a part of steps of above-mentioned methods. In addition, the processing component 802 may include one or more modules configured to facilitate the communication between the processing component 802 and other components. For instance, the processing component 802 may include a multimedia module to facilitate the communication between the multimedia component 808 and the processing component 802.

The memory 804 is configured to store various types of data to support the operations of device 800. The examples of these types of data include instructions of any application programs or methods operated in the device 800, contact information, telephone directory data, messages, pictures, videos and so on. The memory 804 may be realized by any types of volatile or non-volatile memory devices or combinations thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic storage, a flash memory, a magnetic disk or an optical disk.

The power component 806 may provide electric power for various modules in the device 800. The power component 806 may include power management system, one or more power supply and other modules related to generating, managing and distributing power for the device 800.

The multimedia component 808 may include a screen for providing an output interface between the device 800 and the user. In some exemplary embodiments, the screen may include a Liquid Crystal Display (LCD) and a touch panel (TP). If the screen contains the touch panel, it can be realized as a touch screen for receiving input signals from the user. The touch panel may include one or more touch sensors for sensing touching, sliding and gestures on the touch panel. The touch pad may not only sense the boundary of touching or sliding operation, but also detect the duration and pressure related to the touching or sliding operation. In some exemplary embodiments, the multimedia component 808 may include a front camera and/or a rear camera. When the device 800 is under an operation mode such as a photo mode or a video mode, the front camera and/or the rear camera may receive external multimedia data. Each of the front camera and the rear camera may be a fixed optical lens system or may have focal distance and optical zooming ability.

The audio component 810 is configured to output and/or input audio signals. For example, audio component 810 may include a microphone (MIC), and when the device 800 is under an operational mode such as a calling mode, a recording mode or a voice recognition mode, the MIC may be configured to receive external audio signals. The received audio signals may be further stored in the memory 804 or sent out via the communication component 816. In some exemplary embodiments, the audio component 810 may further include a speaker for outputting audio signals.

I/O port 812 provides an interface between the processing component 802 and external interface modules. The external interface module may be a keyboard, a click wheel or button etc. These buttons may include, but be not limited to, a homepage button, a volume button, a start button and a locking button.

The sensor component 814 may include one or more sensors configured to provide respective aspects of status assessment for the device 800. For instance, the sensor component 814 may detect the on/off status of the device 800 and relative positioning among components, for example, the components may be a screen and a small keypad of the device 800. The sensor component 814 may further detect a position change of the device 800 or of a component of the device 800, whether there is a contact between the user and the device 800, an orientation, or an acceleration/deceleration of the device 800 and a temperature change of the device 800. The sensor component 814 may include a proximity detector configured to detect the existence of nearby object without any physical contact. The sensor component 814 may further include optical sensors such as CMOS or CCD imaging sensors for using in image application. In some exemplary embodiments, the sensor component 814 may further include an acceleration sensor, a gyroscope sensor, a magnetic sensor, a pressure sensor or a temperature sensor.

The communication component 816 is configured to facilitate a wired or wireless communication between the device 800 and other devices. The device 800 may access to a wireless network based on a communication standard, such as WiFi, 2G or 3G, or combinations thereof. In one exemplary embodiment, the communication component 816 may receive broadcast signals or information related to broadcast from an external broadcast management system via broadcast channels. In one exemplary embodiment, the said communication component 816 may further include near-field communication (NFC) module configured to facilitate short range communication. For instance, the NFC module may be realized, based upon technologies of Radio Frequency Identification (RFID), Infrared Data Association (IrDA), Ultra Wideband (UWB) or Bluetooth (BT) or other technologies.

In some exemplary embodiments, the device 800 may be realized by one or more application specific integrated circuits (ASIC), Digital Signal Processors (DSP), Digital Signal Processor Devices (DSPD), Programmable Logic Devices (PLD), Field Programmable Gate Arrays (FPGA), controllers, microcontrollers, microprocessors or other electronic components, which are configured to perform the above-mentioned methods.

In some exemplary embodiments, a non-transitory computer readable storage medium including instructions is further provided, e.g. the memory 804 including the instructions. These instructions may be processed by the processor 820 of the device 800 to carry out the above-mentioned method. For instance, the non-transitory computer readable storage medium may be a ROM, a Random Access Storage (RAM), a CD-ROM, a magnetic tape, a floppy disk, an optical data storage device and so on.

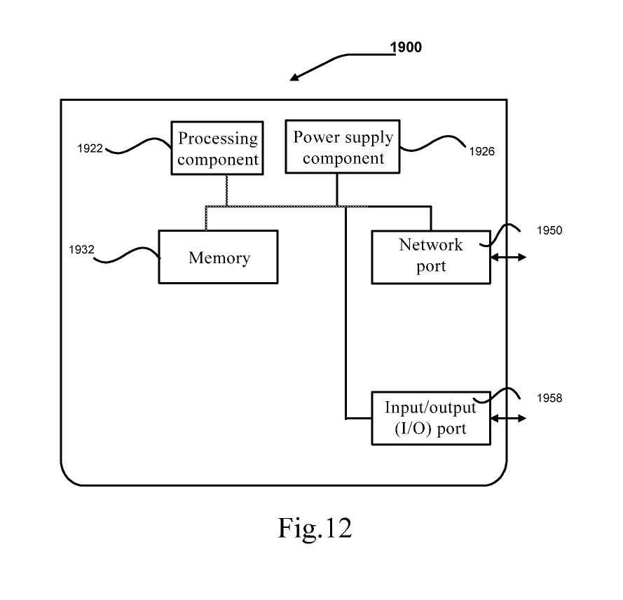

FIG. 12 is a block diagram of a device 1900 for managing processes of an application program according to a second exemplary embodiment. For instance, the device 1900 may be provided as a server. Referring to FIG. 12, the device 1900 may include a processing component 1922 which may further include one or more processors; and memory resources represented by a memory 1932, which is configured to store instructions that could be executed by the processing component 1922, e.g. an application program. The application program stored in the memory 1932 may include one or more modules each of which corresponds to a group of instructions. In addition, the processing component 1922 is configured to execute the instructions, so as to perform the above-mentioned processing methods for the application programs.

The device 1900 may further include a power supply component 1926 configured to perform the power supply management of the device 1900; a wired or wireless network port 1950 configured to connect the device 1900 to a network; and an input/output (I/O) port 1958. The device 1900 may operate operating systems based and stored in the memory 1932, such as Windows Server™, Mac OS X™, Unix™, Linux™, FreeBSD™ and the like.

Upon the consideration of the specification and practice of present disclosure, those skilled in the art shall readily obtain other embodiments of the present disclosure. The present disclosure is intended to cover any variations, purposes or specialization which are complied with the general principles of present disclosure and further include the common knowledge or customary technical means undisclosed in present disclosure. The specification and embodiments are merely regarded as exemplary. The actual scope and spirit of the present disclosure are defined by the appended claims.

It shall be understood by those skilled in the art that the present disclosure is not limited to the precise structures described above and illustrated in accompanying drawings, and various modifications and transformations within the scope of the present disclosure may be made. The scope of the present disclosure is only defined by the appended claims.

What is claimed is:

1. A method for managing processes of an application program, comprising:
switching an application program from running in foreground to running background, wherein processes of the application program comprise a user interface (UI) process and a logic process; and
terminating the UI process of the application program and keeping the logic process of the application program running.

2. The method of claim 1, wherein the method further comprises:
recreating the UI process of the application program according to the logic process when switching the application program from running background to running foreground.

3. The method of claim 1, wherein before switching the application program from running foreground to running background, the method further comprises:
reading out a logic process identifier and/or a UI process identifier from a configuration file of the application program when starting up the application program;
classifying subprograms of the application program into at least a UI class and a logic class according to the logic process identifier and the UI process identifier; and
running subprograms of the application program classified as the UI class in the UI process and running subprograms of the application program classified as the logic class in the logic process.

4. The method of claim 1, wherein after switching the application program from running foreground to running background, the method further comprises:
determining a running time of the application program running in background; and
terminating the UI process of the application program when the running time of the application program running in background exceeds a predetermined time.

5. The method of claim 2, wherein after switching the application program from running foreground to running background, the method further comprises:
determining a running time of the application program running in background; and
terminating the UI process of the application program when the running time of the application program running in background exceeds a predetermined time.

6. The method of claim 3, wherein after switching the application program from running in foreground to running in background, the method further comprises:
determining a running time of the application program running in background; and
terminating the UI process of the application program when the running time of the application program running in background exceeds a predetermined time.

7. The method of claim 1, wherein after switching the application program from running foreground to running background, the method further comprises:
determining a quantity of UI processes running in background; and
terminating the UI process of the application program when the quantity of UI processes running background exceeds a predetermined quantity.

8. The method of claim 2, wherein after switching the application program from running in foreground to running in background, the method further comprises:
determining a quantity of UI processes running in background; and
terminating the UI process of the application program when the quantity of UI processes running in background exceeds a predetermined quantity.

9. The method of claim 3, wherein after switching the application program from running in foreground to running in background, the method further comprises:
determining a quantity of UI processes running in background; and
terminating the UI process of the application program when the quantity of UI processes running in background exceeds a predetermined quantity.

10. A device for managing processes of an application program, comprising:
a processor; and
a memory for storing instructions executable by the processor;
wherein the processor is configured to perform:
switching an application program from running in foreground to running in background, wherein processes of the application program comprise a user interface (UI) process and a logic process; and
terminating the UI process of the application program and keeping the logic process of the application program running.

11. The device of claim 10, wherein the processor is further configured to perform:
recreating the UI process of the application program according to the logic process when switching the application program from running in background to running in foreground.

12. The device of claim 10, wherein before switching the application program from running in foreground to running in background, the processor is further configured to perform:
reading out a logic process identifier and/or an UI process identifier from a configuration file of the application program when starting up the application program;
classifying subprograms of the application program into at least a UI class and a logic class according to the logic process identifier and the UI process identifier; and
running subprograms of the application program classified as the UI class in the UI process and running subprograms of the application program classified as the logic class in the logic process.

13. The device of claim 10, wherein after switching the application program from running in foreground to running in background, the processor is further configured to perform:
determining a running time of the application program running in background; and
terminating the UI process of the application program when the running time of the application program running in background exceeds a predetermined time.

14. The device of claim 11, wherein after switching the application program from running in foreground to running in background, the processor is further configured to perform:
determining a running time of the application program running in background; and
terminating the UI process of the application program when the running time of the application program running in background exceeds a predetermined time.

15. The device of claim 12, wherein after switching the application program from running in foreground to running in background, the processor is further configured to perform:
determining a running time of the application program running in background; and
terminating the UI process of the application program when the running time of the application program running in background exceeds a predetermined time.

16. The device of claim 10, wherein after switching the application program from running in foreground to running in background, the processor is further configured to perform:
determining a quantity of UI processes running in background; and
terminating the UI process of the application program when the quantity of UI processes running in background exceeds a predetermined quantity.

17. The device of claim 11, wherein after switching the application program from running in foreground to running in background, the processor is further configured to perform:
determining a quantity of UI processes running in background; and
terminating the UI process of the application program when the quantity of UI processes running in background exceeds a predetermined quantity.

18. The device of claim 12, wherein after switching the application program from running in foreground to running in background, the processor is further configured to perform:
determining a quantity of UI processes running in background; and
terminating the UI process of the application program when the quantity of UI processes running in background exceeds a predetermined quantity.

19. A non-transitory storage medium having stored therein instructions that, when executed by one or more processors of a device for an application program, causes the device to perform:
switching an application program from running in foreground to running in background, wherein processes of the application program comprise a user interface (UI) process and a logic process; and
terminating the UI process of the application program and keeping the logic process of the application program running.
